(19) United States
(12) Patent Application Publication
(10) Pub. No.: US 2021/0174653 A1
(43) Pub. Date: Jun. 10, 2021

(54) SYSTEM FOR DETECTING PERSONS IN AN AREA OF INTEREST

(71) Applicant: ROLLOOS HOLDING B.V., Capelle aan den IJssel (NL)

(72) Inventors: Bram MASSELINK, Voorburg (NL); Joost LASSCHUIT, Capelle aan den IJssel (NL); Aalzen WIEGERSMA, Drachten (NL)

(73) Assignee: ROLLOOS HOLDING B.V., Capelle aan den IJssel (NL)

(21) Appl. No.: 16/771,961

(22) PCT Filed: Dec. 12, 2018
(86) PCT No.: PCT/NL2018/050834

§ 371 Date: Jun. 11, 2020

(30) Foreign Application Priority Data
Dec. 12, 2017 (NL) 2020067

(51) Int. Cl. G08B 13/196; G06K 9/00

(52) U.S. Cl. CPC G08B 13/19682; G08B 13/19645; G06K 2009/00738; G06K 9/00711; G08B 13/19691

(57) ABSTRACT

The present invention relates to a system for detecting persons in an area of interest, comprising at least one camera, arranged for generating a stream of images of the area of interest, processing means, for processing the generated stream of images, configured for determining the actual locations of presence of persons in each image of the stream of images, thus generating a stream of actual locations of presence of persons, incorporating the stream of actual locations of persons in a schematic view of the area, thus generating a stream of images comprising a schematic view of the area with actual locations of presence of persons, and display means, for displaying the stream of images comprising a schematic view of the area with actual locations of presence of persons.

The present invention relates to a system for detecting persons in an area of interest. In particular the invention relates to such system for use on a drilling rig.

On drilling rigs, safety is an important issue. So called red zones are defined, in which, during or prior to certain operations, no people are allowed to be. The main goals for the red zone people detections system are detecting the presence of people and to distinguish them from equipment or other (moving) objects, determining the location of the detected people on the drill floor, alarming the detected persons and the operators for the presence of people on positions where they should not be at that time and logging and recording events and the movement of people on the drill floor, that can be looked into afterwards. Additionally, the system may be used for giving clear insights of the presence of people on the drill floor to the operators.

The Red-Zone People detection needs to detect workers standing and/or walking in a red-zone on the drill floor during (e.g. drilling) operation. To be able to do so, the worker has to be visible to the system and the system needs to be capable to decide whether that worker is inside or outside the red-zone at a moment that is applicable or not.

Various systems exist for improving the safety in working environments in general, and on drilling rigs in particular. They cover a wide range from systems with cameras and operators who constantly monitor the areas of interest, to movement detection systems that trigger alarms. One difficulty in general is that operators need to be able to distinguish people from the background, machinery and or other moving objects, which additionally may obstruct the view on the moving persons. Further considerations are that it is not preferable that active or passive sensors should be worn by the persons on the drilling rig in order to be able to be detected, since such requirements can be omitted, causing risks.

The US Patent application US 2015/356840 describes a system according to the preamble of claim 1. Such system has the disadvantage however, that the red-zone has a fixed position with respect to the rest of the world, and that it is always considered as a red zone, unless the monitoring system is switched off. In practice, the dangerous area and thus the red zone can change however due to change of position of equipment or due to the status of equipment, or due to external factors.

European patent application EP 3 112 900 aims to solve this problem by fixing the camera system to a drilling machine. However, herewith the red-zone is still fixed to the ground area right below the drilling machine and to the camera, to which in practice the red zone is not always and not under every condition limited.

It is a goal of the present invention to provide a system for detecting persons in an area of interest that takes away the objections of the prior art, and at least provides a useful alternative thereto.

Furthermore, the invention aims to provide a system that is allowable in an environment with danger of explosions (Ex), which sets special requirements to the equipment used.

Although more advantageous systems state to be able to automatically detect people, it has appeared that in practice, the existing systems do not meet nowadays requirements.

It is therefore a goal of the present invention to provide a system for detecting persons in an area of interest, that takes away the disadvantages of the prior art, or at least provides a useful alternative to the prior art.

The invention thereto proposes a system for detecting persons in an area of interest, comprising at least one camera, arranged for generating a stream of images of the area of interest, processing means, for processing the generated stream of images, configured for determining the actual locations of presence of persons in each image of the stream of images, thus generating a stream of actual locations of presence of persons, incorporating the stream of actual locations of persons in a schematic view of the area, thus generating a stream of images comprising a schematic view of the area with actual locations of presence of persons, display means, for displaying the stream of images comprising a schematic view of the area with actual locations of presence of persons wherein setting which area may be entered by a person can be performed manually by an operator, automatically by following machine conditions or positions based on information given by the machine, or their position be determined based on machine conditions or positions derived from camera images. In particular, in the system according to the invention, the one or more cameras are located outside a machine that forms a dangerous or red zone, that is, on a specific or dedicated support. The support is be at a fixed location.

The system according to the invention has several advantages over the prior art. Firstly, it provides a schematic view, which is easier to interpret by an operator than an actual camera view. The schematic view may be a (line) drawing, but also be an annotated camera view or a still. The still may for instance also be sharpened or be processed, in order to make it better readable. It may for instance be taken under better weather conditions or light conditions. Secondly it provides an indication of the actual positions of persons, so that an operator can directly see if a person is at an allowed or at a forbidden location.

In a particular embodiment, the system may be configured to assign a status to a red-zone, or a part thereof. Such status may for instance be “active” or “deactivated”. The status may be assigned to the red-zone based on several decision criteria.

In a first mode, the red zone may be assigned the status “active” or “deactivated” based on machine conditions or positions derived from camera images. The machine in question is in particular a machine in the view of the camera, but not supporting the camera. A part from positions, it may also be a property, such as “hot”, “under high tension”, “sharp” or “acid”, or a movement. The actual location of the red zone may alter dependent on the same or other conditions.

In a second mode, the red zone may be determined by an operational mode or status. Such mode or status is defined here as the result of a sequence or combination of steps or conditions or positions as described above. A choice can be made whether an operator or the system itself determines the mode or status. In an embodiment, the mode may be determined by the system itself based on rules, but it may give an operator the option to overrule such determination.

The status of the red-zone may furthermore be made clear to persons in the red-zone, by providing audiovisual signals, such as red or green light or horn signals.

The processing means may further be configured for comparing subsequent images and relating detected locations of presence of persons in subsequent images to each other. These locations of presence of persons that belong to the same person are provided with a common ID. Locations of a person in a predetermined number of previous images are depicted in an actual image. A different indication may be used for previous locations as for the actual location. The actual location may for instance be depicted with a large dot and previous locations may be indicated with smaller dots. These smaller dots may for instance indicate the most recent positions during the last 5 or 10 or 15 seconds, so that a track of a person is shown.

In addition, or instead of the dots, the system may be configured to display a frame with predetermined properties such as shape and color around persons and around objects of interest. This enables an operator to obtain a quick overview of the situation in or around the red-zone.

In a preferred embodiment, determining of the actual locations of presence of persons in each image of the stream of images takes place based on classification. Hereto, a self-learning algorithm may be applied, which combines multiple proven technologies.

Besides the indication of persons, (moving) objects may be indicated. Different indications can be used to mark persons, fixed objects and moving objects.

Such system may be trained with real-life recordings of different user cases, which serve as first basis for learning the algorithm and its feasibility advice. Additionally, true operational recordings are used to further develop the classifiers and the recognition algorithms. The recorded images may then be labeled manually to let the software know what different items look like (e.g. people, moving objects, environmental conditions and ‘static’ background), and finally be used to compare actual camera views with (aspects of) the labeled images. In an embodiment, the entire images are classified.

Object detection is a core problem in computer vision. Detection pipelines generally start by extracting a set of robust features from input images. Then, classifiers or localizers are used to identify objects in the feature space. These classifiers or localizers are run either in sliding window fashion over the whole image or on some subset of regions in the image.

A system that is preferred according to the present invention is a full and complete observation (FACO) system. Such system replaces all of these disparate parts with a single convolutional neural network. The network performs feature extraction, bounding box prediction, nonmaximal suppression, and contextual reasoning all concurrently. Instead of static features, the network trains the features in-line and optimizes them for the detection task.

A FACO-system reasons globally about the image when making predictions. Unlike sliding window and region proposal-based techniques, FACO sees the entire image during training and test time so it implicitly encodes contextual information about classes as well as their appearance. FACO further learns generalizable representations of objects.

The schematic view of the area of interest may be divided into sub-areas, wherein the system provides an interface for the operator for setting whether the actual area corresponding to the sub-area is allowed to be entered by a person.

The system divides the input image into a grid. If the center of an object falls into a grid cell, that grid cell is responsible for detecting that object. Each grid cell predicts bounding boxes and confidence scores for those boxes. These confidence scores reflect how confident the model is that the box contains an object and also how accurate it thinks the box is that it predicts.

To ensure that all workers are detected within the red-zones, visual redundancy may be applied. For that reason, at least a second camera may be pointed at a specific area or red-zone. This provides the necessary redundancy in case something (e.g. second person, or piece of equipment) blocks the line of view of one of the cameras and multiple detections algorithms working in parallel.

To reduce the possibility of objects blocking the view of a camera, it may be positioned at an alternate position as high as possible in the derrick, the framework supporting the drilling apparatus. An advantage hereof is that localization of a detected person on the drill floor is easier looking top-down than having a more frontal view.

The height of the camera with respect to the red-zone may alter during operation, but for an operator it may be desirable to have the same view on the red zone. The system may therefore be configured for automatically adjusting the zoom or focus of the at least one camera such that the operator has a same sized image all the time.

Ex HD and compact (non HD or analog) cameras may be used together to generate the optimal solution. The type of camera may be chosen in dependency of the mounting possibilities and observation area.

The algorithm may be configured to produce alarm outputs that are integrated with notification elements, like a horn and/or lights. Obviously, these outputs can also be provided to communication systems.

The invention will now be elucidated into more detail with reference to the following figures. Herein:

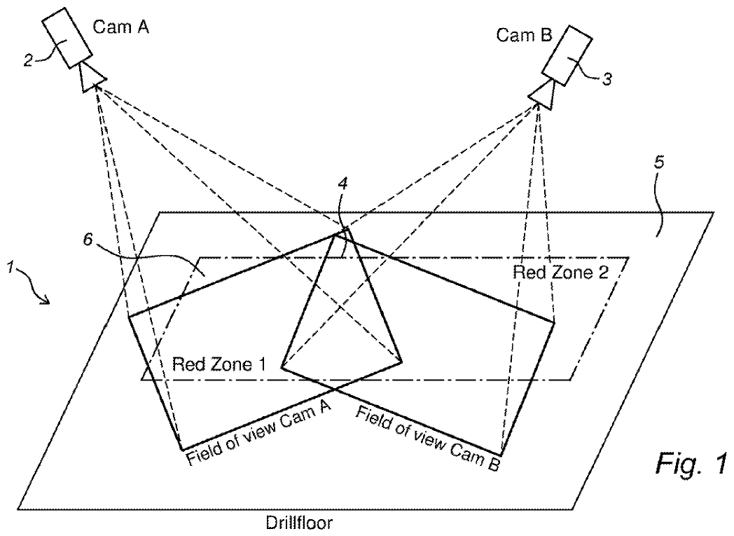

FIG. 1 shows a simplified representation of a system according to the invention;

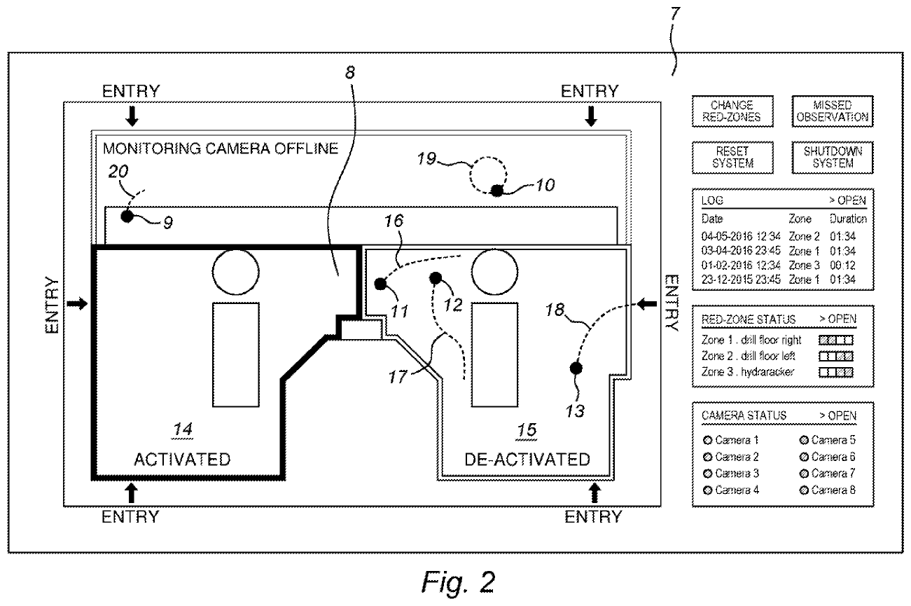

FIG. 2 shows a first screen from a monitor forming part of the present invention;

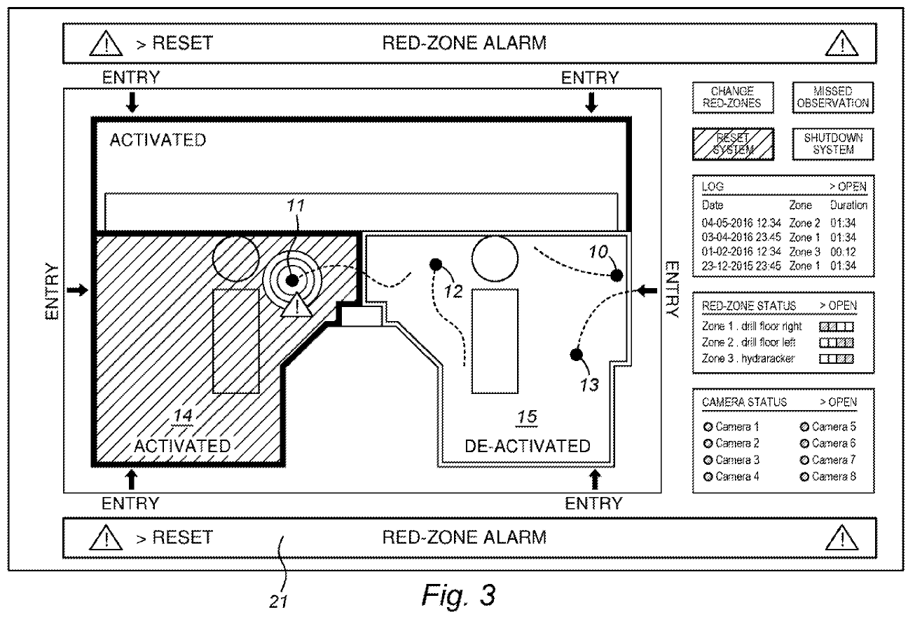

FIG. 3 shows a second screen from the monitor from FIG. 3; and

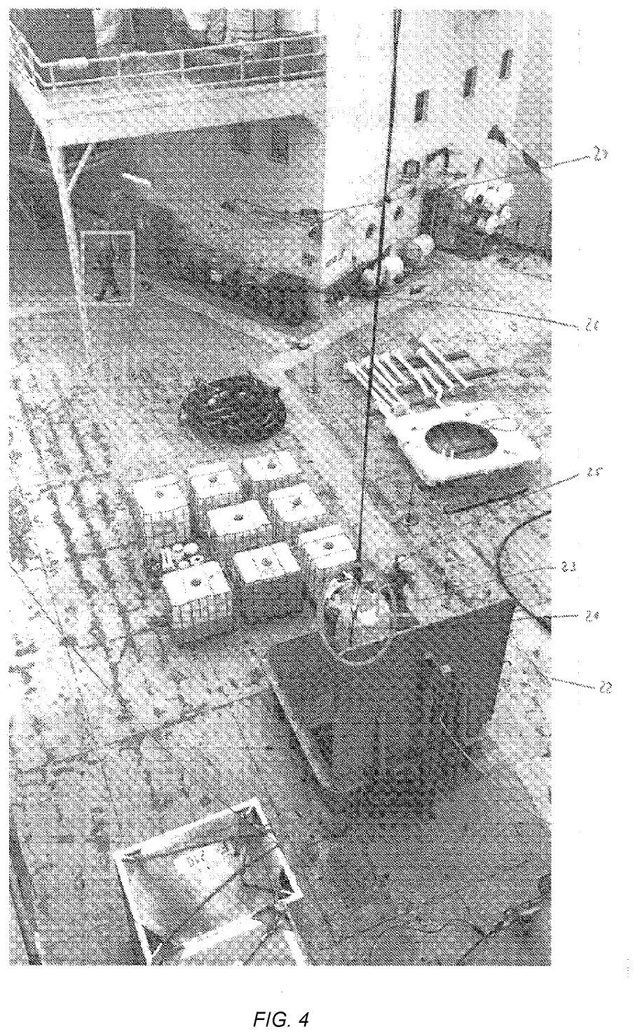

FIG. 4 shows a schematic view provided by a system according to the invention.

FIG. 1 shows a simplified representation of a system 1 for detecting persons in an area of interest, formed by a drilling rig according to the invention. The system comprises three cameras 2, 3 each arranged for generating a stream of images of the area of interest 5. The cameras have an overlapping (redundant) view 4. On the area of interest 5 a red zone 6 is indicated. In this area, no persons are allowed during specific operations. However, also the area of interest outside the red zone 6 is monitored, in order to detect persons heading for the red zone 6 or about to enter the red zone 6. Furthermore, the system allows to follow persons longer, such persons are detected when their position gets closer to a red zone.

The system further comprises processing means (not depicted) for processing the generated stream of images, are configured for determining the actual locations of presence of persons in each image of the stream of images, thus generating a stream of actual locations of presence of persons, and incorporating the stream of actual locations of persons in a schematic view of the area, thus generating a stream of images comprising a schematic view of the area with actual locations of presence of persons, as well as display means for displaying the stream of images comprising a schematic view of the area with actual locations of presence of persons.

FIG. 2 shows a first screen 7 view from a monitor forming part of the present invention. As visible, a schematic view of the area 8 with actual locations of presence of persons 9, 10, 11, 12, 13 is depicted. As visible, the schematic view of the area of interest is divided into sub-areas, 14, 15 and wherein the system provides an interface for setting whether the actual area corresponding to the sub-area is allowed to be entered by a person. The schematic view of the area comprises an indication if a sub-area is allowed to be entered by a person or not. In the given example, the area 14 is activated, which means that persons are not allowed in the area. Area 15 is deactivated, which means that persons are allowed in the area. In the depicted situation, persons 11, 12 and 13 are in the area 15.

The processing means are further configured for comparing subsequent images and relating detected locations of presence of persons in subsequent images to each other. These locations of presence of persons that belong to the same person are provided with a common ID. Locations of a person in a predetermined number of previous images are depicted in an actual image. In the given example, a different indication is used for previous locations as for the actual location. The actual location is depicted with a large dot 11, 12, 13 and the previous locations are indicated with smaller dots, 16, 17, 18, 19, 20. These smaller dots may for instance indicate the most recent positions during the last 5 or 10 or 15 seconds.

FIG. 3 shows the screen from FIG. 2, wherein person 11 has entered the red zone. An alarm signal 21 is shown on the display means. The alarm may also be equipped for enabling an alarm light or an alarm sound at the actual area of interest, such as a light or sound alarm. Which zones are indicated as red zones may change in time, due to the processes carried out on the drilling rig. Setting the actual red zone may be done in different ways. A manual setting can be applied by an operator, settings may follow machine conditions or positions, based on information given by the machine, or their position may be determined based on information derived from the cameras.

FIG. 4 shows how the system according to the invention may display a frame 22, 23, 26 with predetermined properties around persons 24, 27 and around an object 25 of interest. This enables an operator to obtain a quick overview of the situation in or around the red-zone.

The examples given are exemplary only and do in no sense limit the scope of protection of the present invention, as defined in the following claims.

1. System for detecting persons in an area of interest, comprising:
At least one camera, arranged for generating a stream of images of the area of interest;
Processing means, for processing the generated stream of images, configured for:
Determining the actual locations of presence of persons in each image of the stream of images, thus generating a stream of actual locations of presence of persons;
Incorporating the stream of actual locations of persons in a schematic view of the area, thus generating a stream of images comprising a schematic view of the area with actual locations of presence of persons;
Display means, for displaying the stream of images comprising a schematic view of the area with actual locations of presence of persons wherein setting which area may be entered by a person can be performed manually by an operator, automatically by following machine conditions or positions based on information given by the machine, or their position be determined based on machine conditions or positions derived from camera images.

2. System according to claim 1, wherein multiple cameras are applied for providing redundancy in case something or someone blocks the line of view of the at least one camera.

3. System according to claim 1, wherein at least one camera is arranged above and preferably on top of the area of interest, for example in a derrick, for providing a top view of the area of interest.

4. System according to claim 1, wherein determining of the actual locations of presence of persons in each image of the stream of images takes place based on classification.

5. System according to claim 4, wherein the entire image is classified.

6. System according to claim 4 or 5, wherein classification takes place by means of a convolutional neural network.

7. System according to claim 6, wherein the convolutional neural network is trained based on labeled images.

8. System according to claim 1, wherein the schematic view of the area of interest is divided into sub-areas, and wherein the system provides an interface for setting whether the actual area corresponding to the sub-area is allowed to be entered by a person.

9. System according to claim 8, wherein the schematic view of the area comprises an indication if a sub-area is allowed to be entered by a person or not.

10. System according to claim 8, configured for providing an alarm signal when a person is detected within a predetermined distance from a sub area which is set not to be allowed to be entered.

11. System according to claim 10, wherein the alarm signal is shown on the display means.

12. System according to claim 10, wherein the alarm signal is used for enabling an alarm light or an alarm sound at the actual area of interest.

13. System according to claim 1, wherein the processing means are configured for:
Comparing subsequent images; and
Relating detected locations of presence of persons in subsequent images to each other.

14. System according to claim 13, wherein the locations of presence of persons in subsequent images that belong to the same person are provided with a common ID.

15. System according to claim 14, wherein locations of a person in a predetermined number of previous images are depicted in an image.

16. System according to claim 15, wherein different indicators are used for actual and previous positions for displaying the stream of images comprising a schematic view of the area with actual locations of presence of persons.

17. System according to claim 2, wherein at least one camera is arranged above and preferably on top of the area of interest, for example in a derrick, for providing a top view of the area of interest.

18. System according to claim 5, wherein classification takes place by means of a convolutional neural network.

19. System according to claim 9, configured for providing an alarm signal when a person is detected within a predetermined distance from a sub area which is set not to be allowed to be entered.

20. System according to claim 11, wherein the alarm signal is used for enabling an alarm light or an alarm sound at the actual area of interest.
